(19) United States
(12) Patent Application Publication
(10) Pub. No.: US 2010/0059038 A1
(43) Pub. Date: Mar. 11, 2010

(54) Portable Barbecue Device

(76) Inventor: Wei-Teh HO, Taipei City (TW)

Correspondence Address: HDLS IPR Services, PO Box 220746, Chantilly, VA, 20153, US

(21) Appl. No.: 12/554,978

(22) Filed: Sep. 7, 2009

(30) Foreign Application Priority Data
Sep. 5, 2008 (CN) 200820200124.4

(51) Int. Cl. A47J 37/07; A47J 43/00

(52) U.S. Cl. 126/25 R; 99/448

(57) ABSTRACT

A portable barbecue device includes a heating chamber, a base portion and a plurality of food supporting elements. The food supporting elements may be a plurality of sticks. The heating tube is disposed inside the heating chamber. A plurality of slots are provided on one side of the base portion so as to hold the sticks in place. The motor of the barbecue device may be turned on so that the sticks with food thereon may be rotated around automatically. The output axle of the motor is connected with a set of cogwheels. The cogwheels may mesh with each other or a transmission wheel may be provided between each pair of the cogwheels. Hence, the motor may be turned on to rotate the sticks.

### BACKGROUND OF THE INVENTION

1. Field of the Invention

The invention generally relates to a portable barbecue device.

2. Description of the Prior Art

In the contemporary society, with the fast development of urbanization, work and daily life become ever more stressful. People start to put more emphasis on their leisure activities and hope to use leisure activities to balance their life.

Among the leisure activities, barbecue activity is a popular one. The process of barbecue activity allows people to relax and enjoy delicious food and each other's company.

In the traditional barbecue activity, we have to prepare food, metal net, charcoal, etc. If something goes wrong, such barbecue activity may be greatly affected and quarrels may occur between friends.

In addition, the use of improper barbecue devices may create a lot of garbage, grease and ash, which may pollute our environment and even cause fires.

### SUMMARY OF THE INVENTION

The main object of the present invention is to provide a portable barbecue device that is easy to use and may be used on different types of floors and provides the selection of several types of food supporting elements or cooking elements, allowing smokeless cooking and the enhancement of the pleasure of barbecuing.

Another object of the present invention is to provide a portable barbecue device that is compact and easy to carry around so that it may be carried in an automobile and may be used in our home. The portable barbecue device of the present invention becomes even more valuable in a crowded urban area where space is limited.

A third object of the present invention is to provide a portable barbecue device that is environmentally friendly because it allows grease and food particles to be gathered and discarded.

The portable barbecue device of the present invention comprises a heating chamber, a base portion and a plurality of food supporting elements. The heating tube supplies heat to the heating chamber. Several reflective metallic plates are placed by the heating tube. A heat outlet is located at the bottom portion of the heating chamber. A protective net is disposed at the heat outlet of the heating chamber. A plurality of heat dissipating holes are disposed on the top cover of the heating chamber. The heating chamber is supported by a base portion through four vertical supporting rods. Now, food may be put onto these food supporting elements. The food on the elements may be cooked by the heat emitted downwards from the heating tube. A control compartment is disposed on one side of the base portion. We can choose proper food supporting elements or cooking elements to cook food and the control compartment can automatically rotate the food supporting elements or cooking elements. A grease collecting pan is used to catch the grease and food particles. Therefore, the portable barbecue device of the present invention is easy to carry around and is environmentally friendly because it allows grease and food particles to be gathered and discarded.

### BRIEF DESCRIPTION OF THE DRAWINGS

The drawings disclose several illustrative embodiments of the present invention which serves to exemplify the various advantages and objects hereof, and are as follows:

FIG. 1 is a perspective view illustrating the portable barbecue device of the present invention.

FIG. 2 is a bottom view for the heating chamber of the portable barbecue device of the present invention.

FIG. 3 is a perspective view illustrating a stick of the portable barbecue device of the present invention with a positioning ring.

FIG. 4 is a perspective view illustrating a stick of the portable barbecue device of the present invention with a positioning ring and a food retaining piece.

FIG. 5 is an exploded view illustrating the control compartment of the portable barbecue device of the present invention.

FIG. 6 is another exploded view illustrating the control compartment of the portable barbecue device of the present invention.

FIG. 7 is a perspective view illustrating the use of a cooking tray in the portable barbecue device of the present invention.

FIG. 8 is a perspective view illustrating the use of a net placed above the cooking tray in the portable barbecue device of the present invention.

FIG. 9 is a perspective view illustrating the use of a rotational cooking cage in the portable barbecue device of the present invention.

### DETAILED DESCRIPTION OF THE PREFERRED EMBODIMENT

These features and advantages of the present invention will be fully understood and appreciated from the following detailed description of the accompanying drawings.

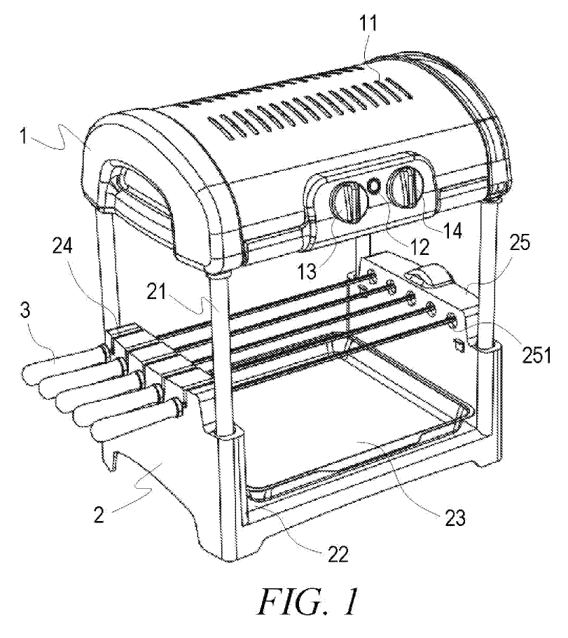

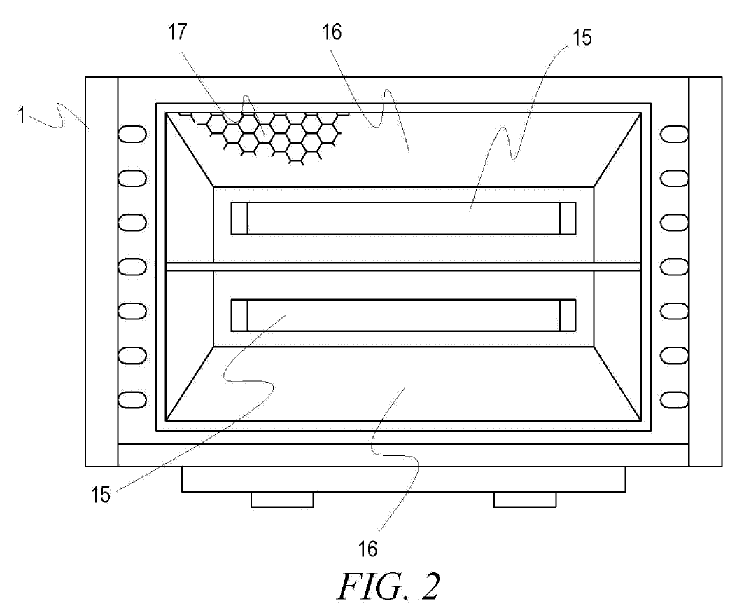

Please refer to FIGS. 1 and 2. The portable barbecue device of the present invention comprises a heating chamber 1, a base portion 2 and a plurality of food supporting elements 3. A heating tube 15 supplies heat to the heating chamber 1 and outputs heat downwards. A plurality of heat dissipating holes 11 are disposed on the top cover of the heating chamber 1 to regulate the temperature in the heating chamber 1. The heating chamber 1 is supported by a base portion 2 through four vertical supporting rods 21. In addition, each of the four vertical supporting rods 21 are retractable to allow the portable barbecue device of the present invention to become more compact so that it may be carried around or stored away more easily.

We may place the food supporting elements 3 (in this embodiment, they are sticks 3) on the base portion 2 and then food may be put onto these sticks. Now, the food on the sticks may be cooked by the heat emitting downwards from the heating tube 15. A power indicator light 12, a temperature adjustment knob 13 and a cooking time knob 14 are disposed on the front exterior wall of the heating chamber 1 for easy access. When the heating tube 15 is turned on, the indicator light 12 would be lit. We can use the temperature adjustment knob 13 to adjust the temperature of the heating tube 15. Other type of knob may also be used.

The portable barbecue device of the present invention is a smokeless electric barbecue device. The heating tube 15 is disposed inside the heating chamber 1. Several reflective metallic plates 16 are placed by the heating tube 15 to distribute the heat evenly in the heating chamber 1. A protective net 17 is disposed at the heat outlet of the heating chamber 1. The net 17 can allow the passage of the heat and prevent a user from getting accidental contact with the heating tube 15. Therefore, with such structure, no smoke would be generated in the cooking process. Two or more heating tubes 15 may be used. Two heating tubes 15 are used in this embodiment. A set of reflective metallic plates 16 may be provided for each heating tube 15 for the even distribution of the heat.

The bottom part of the base portion 2 is a flat surface 22 and a grease collecting pan 23 is placed on the flat surface 22. The pan 23 may catch the grease and food particles.

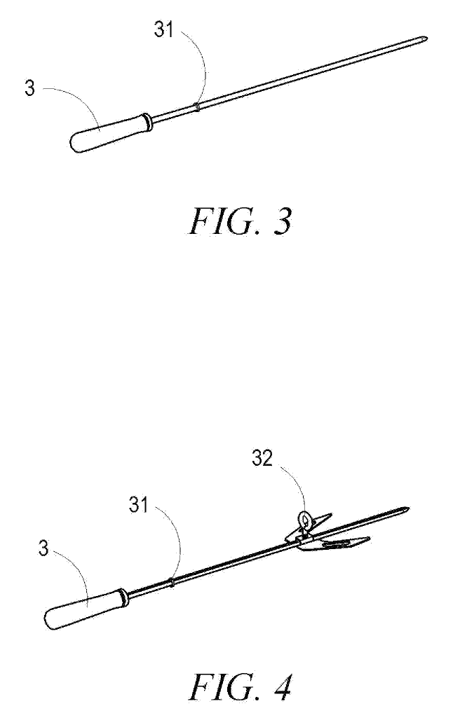

Now, please see FIGS. 3 and 4. The portable barbecue device of the present invention provides the selection of several types of food supporting elements or cooking elements. In this embodiment, the sticks 3 are used. Several slots 24 are provided in one side wall of the base portion 2 to hold the sticks 3. A control compartment 25 is provided on another side of the base portion 2. A hole 251 corresponding to each slot 24 is provided in the control compartment 25. The holes 251 can hold the distal end of each stick 3. Food may be put on these sticks 3 and the control compartment 25 can automatically rotate the food on these sticks 3 to cook it evenly.

A positioning ring 31 may be used for each stick 3 to assist the positioning of each stick 3 in the corresponding slot 24. A food retaining piece 32 may be used for each stick 3 to securely hold the food on each stick 3 while the sticks 3 are rotated.

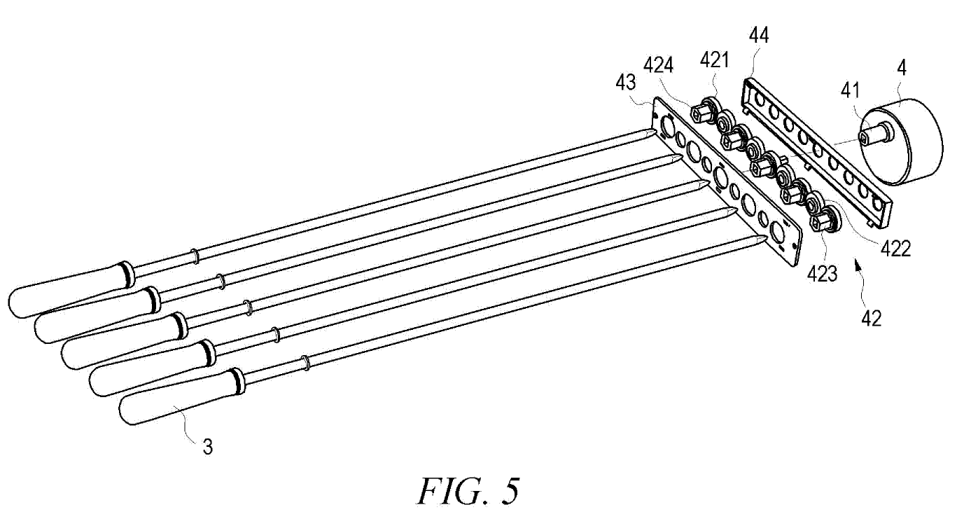

Please refer to FIG. 5, which illustrates the structure of the control compartment 25. A motor 4 is disposed in the control compartment 25. The output axle 41 of the motor 4 is connected with a set of cogwheels 42. Two enclosure pieces 43 and 44 are provided so that the set of cogwheels 42 may be properly positioned. The set of cogwheels 42 includes a plurality of cogwheels 421; the cogwheels 421 may mesh with each other or a transmission wheel 422 may be provided between each pair of the cogwheels 421. A positioning piece 423 is provided on each cogwheel 421 and extends beyond a corresponding hole in the enclosure piece 43. A positioning hole 424 is centrally provided in each positioning piece 423. In use, the proximal portion and distal end of each stick 3 may be placed in a slot 24 and a positioning hole 424, respectively; now, the motor 4 may be turned on to rotate the sticks 3. To ensure a tight fit, the distal end of each stick 3 and each positioning hole 424 has a polygonal shape so that the distal end of each stick 3 may be fixedly held inside the corresponding positioning hole 424.

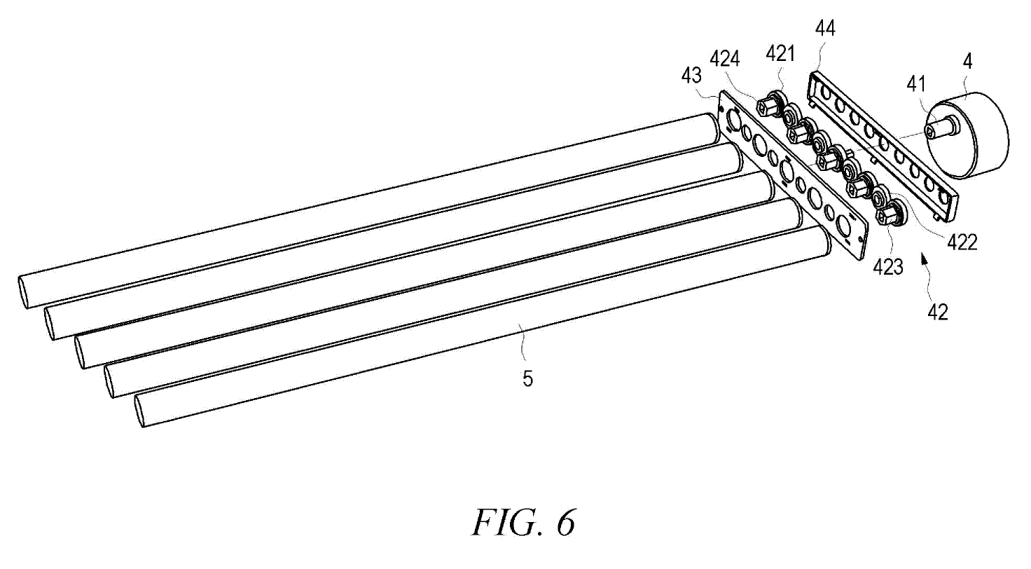

Also, as illustrated in FIG. 6, several cylindrical rollers may be used to cook food. To install these rollers, we only have to connect the distal end of each roller 5 with the corresponding positioning piece 423; the connection may be secured because both the engagement part at the distal end of each roller 5 and each positioning piece 423 have a polygonal shape. Then, the motor 4 may be turned on to rotate the rollers 5.

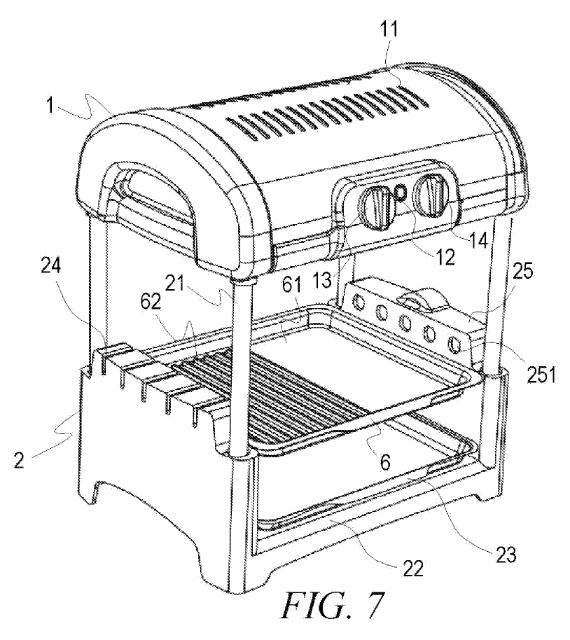

Now, please see FIG. 7. A cooking tray 6 is used. Food may be placed on the tray to cook. The cooking surface of the cooking tray 6 may be a smooth surface 61 or a rugged surface 62 for different cooking needs. The tray 6 may also catch the grease and food particles.

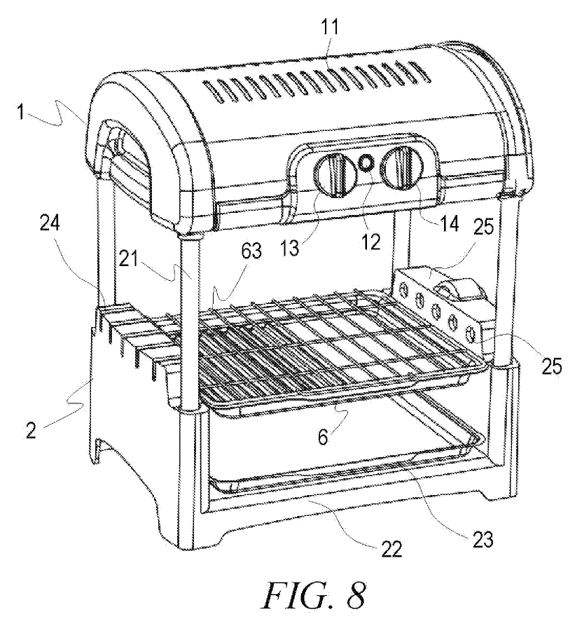

Please refer to FIG. 8. A net 62 may be used above the tray 6. Food may be placed on the net 63 to cook. Optionally, the net 62 may be used without the tray 6; in such case, the pan 23 can catch the grease and food particles.

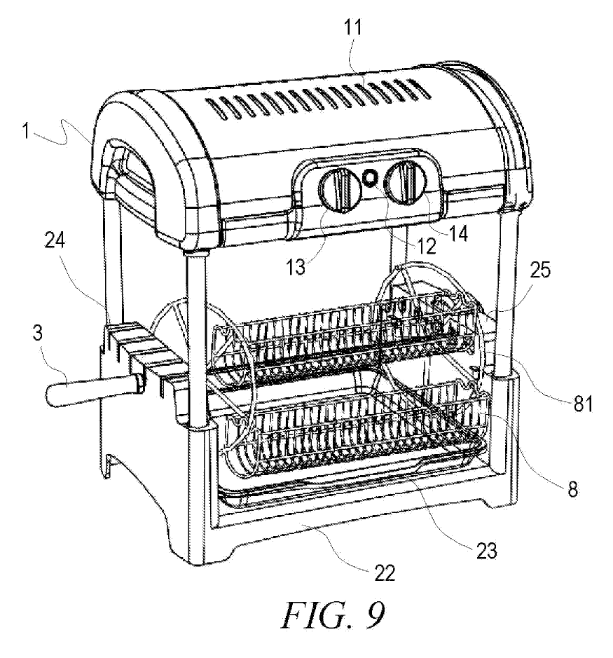

Now, please see FIG. 9. A rotational cooking cage 8 may be used. The rotational cooking cage is fitted onto two end circular pieces 81. The rotational cooking cage 8 and two pieces 81 may be rotated by a stick 3. In this way, food placed in the rotational cooking cage 8 may be rotated and cooked evenly.

In addition, other types of food supporting elements or cooking elements may be used.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A portable barbecue device, comprising:
a heating chamber, in which a heat outlet is located in a bottom portion of the heating chamber to channel the heat downwards;
a base portion, wherein the heating chamber is supported by the base portion through four vertical supporting rods; and
a plurality of food supporting elements, which may be placed on the base portion, wherein the food supporting elements may be cooked by the heat emitted downwards from the heating chamber.

2. The portable barbecue device as in claim 1, wherein two heating tubes are used to cook food and a plurality of heat dissipating holes are disposed on the top cover of the heating chamber, and several reflective metallic plates are placed by the heating tubes to distribute the heat evenly.

3. The portable barbecue device as in claim 1, wherein a protective net is disposed at the heat outlet to avoid accidental contact of a user.

4. The portable barbecue device as in claim 1, wherein an indicator light, a temperature adjustment knob and a cooking time knob are disposed on the front exterior wall of the heating chamber, and the heating tubes would be turned on when the cooking time knob is turned.

5. The portable barbecue device as in claim 1, wherein the bottom part of the base portion is a flat surface and a grease collecting pan is placed on the flat surface to catch the grease and food particles in the cooking process.

6. The portable barbecue device as in claim 1, wherein each of the four vertical supporting rods are retractable to allow the portable barbecue device of the present invention to become more compact so that it may be carried around or stored away more easily.

7. The portable barbecue device as in claim 1, wherein a control compartment is disposed on one side of the base portion and a motor is disposed inside the control compartment, the output axle of the motor is connected with a set of cogwheels and the set of cogwheels includes a plurality of cogwheels, and a positioning piece is provided on each cogwheel and a positioning hole is provided in each positioning piece so that the distal end of each food supporting element may be held by a corresponding positioning piece and that each food supporting element may be rotated around.

8. The portable barbecue device as in claim 1, wherein the food supporting elements are sticks, a positioning hole is disposed in each positioning piece and several slots are provided on the other side in the base portion; in use, the proximal portion and distal end of each stick may be placed in a slot and the corresponding positioning hole, respectively, and the motor can automatically rotate each stick.

9. The portable barbecue device as in claim 8, wherein both the distal end of each stick and each positioning hole have a polygonal shape.

10. The portable barbecue device as in claim 8, wherein a positioning ring is placed on each stick to secure the stick's seating in the corresponding slot.

11. The portable barbecue device as in claim 8, wherein a food retaining piece may be used for each stick to securely hold the food on each stick while the sticks are rotated.

12. The portable barbecue device as in claim 7, wherein the cogwheels may mesh with each other or a transmission wheel may be provided between each pair of the cogwheels.

13. The portable barbecue device as in claim 1, wherein the food supporting elements are several cylindrical rollers and the distal end of each roller may engage with the corresponding positioning piece.

14. The portable barbecue device as in claim 1, wherein both the distal end of each roller and the corresponding positioning piece have a polygonal shape.

15. The portable barbecue device as in claim 1, wherein the food supporting element is a cooking net.

16. The portable barbecue device as in claim 1, wherein the food supporting element is a cooking tray.

17. The portable barbecue device as in claim 16, wherein the cooking surface of the cooking tray may be a smooth surface or a rugged surface for different cooking needs.

18. The portable barbecue device as in claim 16, wherein a net may be used above the cooking tray.

19. The portable barbecue device as in claim 1, wherein the food supporting element is a rotational cooking cage, which is fitted onto two end circular pieces, and the rotational cooking cage and two end circular pieces may be rotated by a stick and the motor.
